(19) United States
(12) Patent Application Publication
(10) Pub. No.: US 2025/0227311 A1
(43) Pub. Date: Jul. 10, 2025

(54) METHOD AND COMPRESSION FRAMEWORK WITH POST-PROCESSING FOR MACHINE VISION

(71) Applicant: Alibaba (China) Co., Ltd., Hangzhou (CN)

(72) Inventors: Binzhe LI, Hangzhou (CN); Shurun WANG, Beijing (CN); Yan YE, San Diego, CA (US)

(21) Appl. No.: 19/002,047

(22) Filed: Dec. 26, 2024

Related U.S. Application Data
(60) Provisional application No. 63/696,890, filed on Sep. 20, 2024.
(60) Provisional application No. 63/619,110, filed on Jan. 9, 2024.

(51) Int. Cl. H04N 19/85; G06V 10/77; G06V 20/40

(52) U.S. Cl. CPC H04N 19/85; G06V 10/7715; G06V 20/46

(57) ABSTRACT

A video processing method includes compressing and reconstructing an original visual signal to obtain a reconstructed visual signal; processing the reconstructed visual signal to obtain a post-processed visual signal; and feeding the post-processed visual signal to a machine task network

### CROSS-REFERENCE TO RELATED APPLICATIONS

The disclosure claims the benefits of priority to U.S. Provisional Application No. 63/619,110, filed Jan. 9, 2024, and U.S. Provisional Application No. 63/696,890, filed Sep. 20, 2024, both of which are incorporated herein by reference in their entireties.

### TECHNICAL FIELD

The present disclosure generally relates to video processing, and more particularly, to a method and a compression framework with post-processing for machine vision.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a video processing method. The method includes compressing and reconstructing an original visual signal to obtain a reconstructed visual signal; processing the reconstructed visual signal to obtain a post-processed visual signal; and feeding the post-processed visual signal to a machine task network.

Embodiments of the present disclosure provide a video procession system. The system includes a codec configured to compress and reconstruct an original visual signal to obtain a reconstructed visual signal; a post-processing network configured to process the reconstructed visual signal to obtain a post-processed visual signal; and a machine task network configured to process the post-processed visual signal.

Embodiments of the present disclosure provide a non-transitory computer readable medium that stores a set of instructions that is executable by one or more processors of an apparatus to cause the apparatus to perform operations. The operations include compressing and reconstructing an original visual signal to obtain a reconstructed visual signal; processing the reconstructed visual signal to obtain a post-processed visual signal; and feeding the post-processed visual signal to a machine task network.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an exemplary system for coding image data, according to some embodiments of the present disclosure.

FIG. 2 is a schematic diagram illustrating structures of an example video sequence, according to some embodiments of the present disclosure.

FIG. 3A is a schematic diagram illustrating an exemplary block-based encoding process, according to some embodiments of the present disclosure.

FIG. 3B is a schematic diagram illustrating another exemplary block-based encoding process, according to some embodiments of the present disclosure.

FIG. 4A is a schematic diagram illustrating an exemplary block-based decoding process, according to some embodiments of the present disclosure.

FIG. 4B is a schematic diagram illustrating another exemplary block-based decoding process, according to some embodiments of the present disclosure.

FIG. 5 is a schematic diagram illustrating an exemplary machine-oriented video compression framework, according to some embodiments of the present disclosure.

FIG. 6A is a schematic diagram illustrating an exemplary video coding for machines (VCM) processing framework, according to some embodiments of the present disclosure.

FIG. 6B is a schematic diagram illustrating another exemplary VCM processing framework, according to some embodiments of the present disclosure.

FIG. 6C is a schematic diagram illustrating another exemplary VCM processing framework, according to some embodiments of the present disclosure.

FIG. 7 is a schematic diagram illustrating an exemplary framework of visual signal compression for machine vision, according to some embodiments of the present disclosure.

FIG. 8 illustrates an exemplary flowchart of a video processing method, according to some embodiments of the present disclosure.

FIG. 9 is a schematic diagram illustrating an exemplary post-processing framework, according to some embodiments of the present disclosure.

FIG. 10 illustrates an exemplary flowchart of a post-processing method, according to some embodiments of the present disclosure.

FIG. 11 is a schematic diagram illustrating another exemplary post-processing framework, according to some embodiments of the present disclosure.

FIG. 12 is a schematic diagram illustrating an exemplary light-weighted post-processing framework, according to some embodiments of the present disclosure.

FIG. 13 is a block diagram of an exemplary apparatus for video processing, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

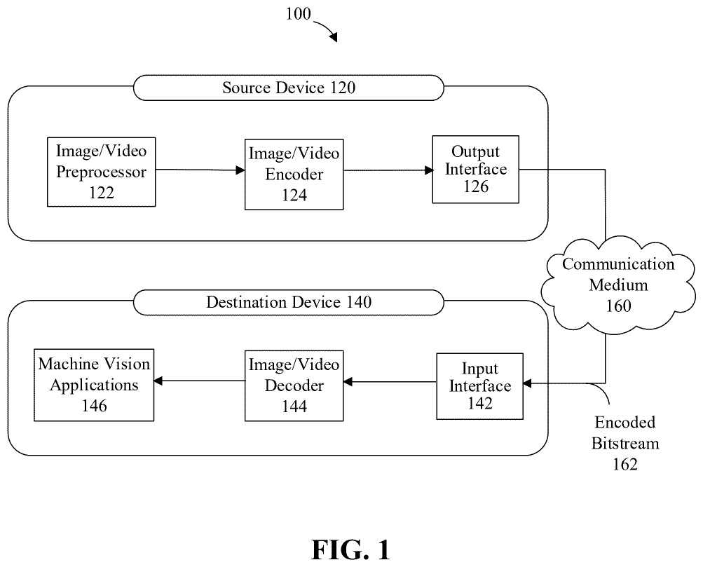

FIG. 1 is a block diagram illustrating a system 100 for coding image data, according to some disclosed embodiments. The image data may include an image (also called a “picture” or “frame”), multiple images, or a video. An image is a static picture. Multiple images may be related or unrelated, either spatially or temporary. A video is a set of images arranged in a temporal sequence.

As shown in FIG. 1, system 100 includes a source device 120 that provides encoded video data to be decoded at a later time by a destination device 140. Consistent with the disclosed embodiments, each of source device 120 and destination device 140 may include any of a wide range of devices, including a desktop computer, a notebook (e.g., laptop) computer, a server, a tablet computer, a set-top box, a mobile phone, a vehicle, a camera, an image sensor, a robot, a television, a camera, a wearable device (e.g., a smart watch or a wearable camera), a display device, a digital media player, a video gaming console, a video streaming device, or the like. Source device 120 and destination device 140 may be equipped for wireless or wired communication.

Referring to FIG. 1, source device 120 may include an image/video preprocessor 122, an image/video encoder 124, and an output interface 126. Destination device 140 may include an input interface 142, an image/video decoder 144, and machine vision applications 146. Image/video encoder 124 encodes the input bitstream and outputs an encoded bitstream 162 via output interface 126. Encoded bitstream 162 is transmitted through a communication medium 160, and received by input interface 142. Image/video decoder 144 then decodes encoded bitstream 162 to generate decoded data.

More specifically, source device 120 may further include various devices (not shown) for providing source image data to be processed by Image/video encoder 124. The devices for providing the source image data may include an image/video capture device, such as a camera, an image/video archive or storage device containing previously captured images/videos, or an image/video feed interface to receive images/videos from an image/video content provider.

Image/video encoder 124 and image/video decoder 144 each may be implemented as any of a variety of suitable encoder or decoder circuitry, such as one or more microprocessors, digital signal processors (DSPs), application specific integrated circuits (ASICs), field programmable gate arrays (FPGAs), discrete logic, software, hardware, firmware, or any combinations thereof. When the encoding or decoding is implemented partially in software, image/video encoder 124 or image/video decoder 144 may store instructions for the software in a suitable, non-transitory computer-readable medium and execute the instructions in hardware using one or more processors to perform the techniques consistent this disclosure. Each of image/video encoder 124 or image/video decoder 144 may be included in one or more encoders or decoders, either of which may be integrated as part of a combined encoder/decoder (CODEC) in a respective device.

Image/video encoder 124 and image/video decoder 144 may operate according to any video coding standard, such as Advanced Video Coding (AVC), High Efficiency Video Coding (HEVC), Versatile Video Coding (VVC), AOMedia Video 1 (AV1), Joint Photographic Experts Group (JPEG), Moving Picture Experts Group (MPEG), etc. Alternatively, image/video encoder 124 and image/video decoder 144 may be customized devices that do not comply with the existing standards. Although not shown in FIG. 1, in some embodiments, image/video encoder 124 and image/video decoder 144 may each be integrated with an audio encoder and decoder, and may include appropriate MUX-DEMUX units, or other hardware and software, to handle encoding of both audio and video in a common data stream or separate data streams.

Output interface 126 may include any type of medium or device capable of transmitting encoded bitstream 162 from source device 120 to destination device 140. For example, output interface 126 may include a transmitter or a transceiver configured to transmit encoded bitstream 162 from source device 120 directly to destination device 140 in real-time. Encoded bitstream 162 may be modulated according to a communication standard, such as a wireless communication protocol, and transmitted to destination device 140.

Communication medium 160 may include transient media, such as a wireless broadcast or wired network transmission. For example, communication medium 160 may include a radio frequency (RF) spectrum or one or more physical transmission lines (e.g., a cable). Communication medium 160 may form part of a packet-based network, such as a local area network, a wide-area network, or a global network such as the Internet. In some embodiments, communication medium 160 may include routers, switches, base stations, or any other equipment that may be useful to facilitate communication from source device 120 to destination device 140. For example, a network server (not shown) may receive encoded bitstream 162 from source device 120 and provide encoded bitstream 162 to destination device 140, e.g., via network transmission.

Communication medium 160 may also be in the form of a storage media (e.g., non-transitory storage media), such as a hard disk, flash drive, compact disc, digital video disc, Blu-ray disc, volatile or non-volatile memory, or any other suitable digital storage media for storing encoded image data. In some embodiments, a computing device of a medium production facility, such as a disc stamping facility, may receive encoded image data from source device 120 and produce a disc containing the encoded video data.

Input interface 142 may include any type of medium or device capable of receiving information from communication medium 160. The received information includes encoded bitstream 162. For example, input interface 142 may include a receiver or a transceiver configured to receive encoded bitstream 162 in real-time.

System 100 can be configured to performing video encoding and decoding based on block-based video compression techniques, deep learning based video compression techniques, talking face video compression techniques, etc.

The block-based video compression techniques use a block-based hybrid video coding framework to exploit the spatial redundancy, temporal redundancy, and information entropy redundancy in videos. This hybrid video coding framework includes motion compensation (e.g., intra/inter prediction), transform (e.g., discrete cosine transform), quantization and entropy coding. The block-based video compression techniques can be made compliant with various image/video coding standards, such as JPEG, JPEG2000, the H.264/MPEG4 part 10, Audio Video coding Standard (AVS), the H.265/HEVC standard, the Versatile Video Coding (VVC) standard, etc.

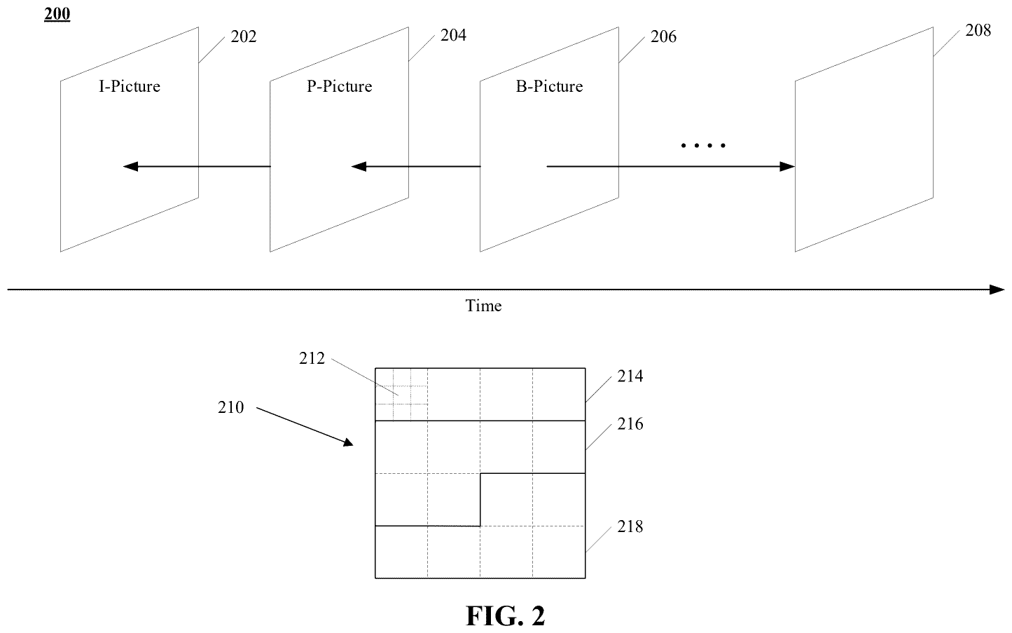

FIG. 2 illustrates structures of an example video sequence 200, according to some embodiments of the present disclosure. Video sequence 200 can be a live video or a video having been captured and archived. Video 200 can be a real-life video, a computer-generated video (e.g., computer game video), or a combination thereof (e.g., a real-life video with augmented-reality effects). Video sequence 200 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 2, video sequence 200 can include a series of pictures arranged temporally along a timeline, including pictures 202, 204, 206, and 208. Pictures 202-206 are continuous, and there are more pictures between pictures 206 and 208. In FIG. 2, picture 202 is an I-picture, the reference picture of which is picture 202 itself. Picture 204 is a P-picture, the reference picture of which is picture 202, as indicated by the arrow. Picture 206 is a B-picture, the reference pictures of which are pictures 204 and 208, as indicated by the arrows. In some embodiments, the reference picture of a picture (e.g., picture 204) can be not immediately preceding or following the picture. For example, the reference picture of picture 204 can be a picture preceding picture 202. It should be noted that the reference pictures of pictures 202-206 are only examples, and the present disclosure does not limit embodiments of the reference pictures as the examples shown in FIG. 2.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 210 in FIG. 2 shows an example structure of a picture of video sequence 200 (e.g., any of pictures 202-208). In structure 210, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC, H.266/VVC, or AVS). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

In structure 210 of FIG. 2, basic processing unit 212 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC, H.266/VVC and AVS provide two types of regions: “slices” and “tiles.” It should also be noted that different pictures of video sequence 300 can have different partition schemes for dividing a picture into regions.

For example, in FIG. 2, structure 210 is divided into three regions 214, 216, and 218, the boundaries of which are shown as solid lines inside structure 210. Region 214 includes four basic processing units. Each of regions 216 and 218 includes six basic processing units. It should be noted that the basic processing units, basic processing sub-units, and regions of structure 210 in FIG. 2 are only examples, and the present disclosure does not limit embodiments thereof.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC, H.266/VVC or AVS). Any operation performed to a basic processing unit can be repeatedly performed to each of its luma and chroma components.

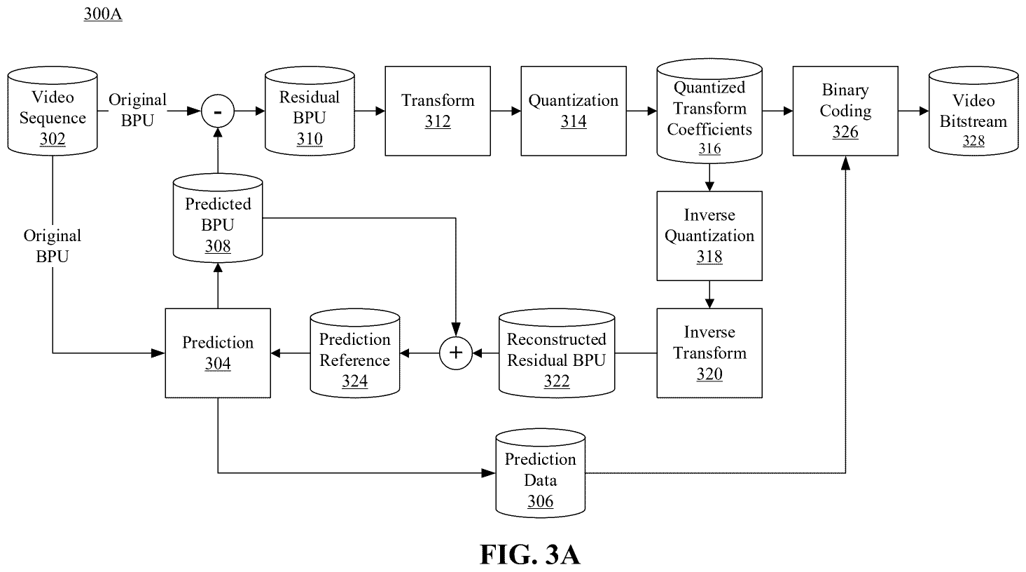

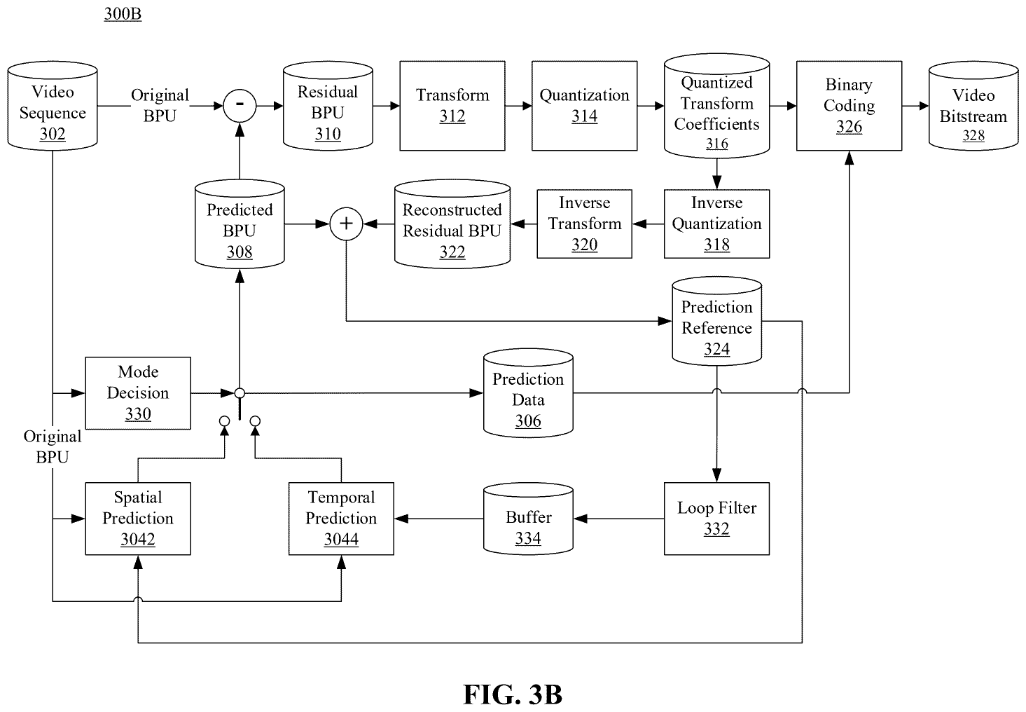

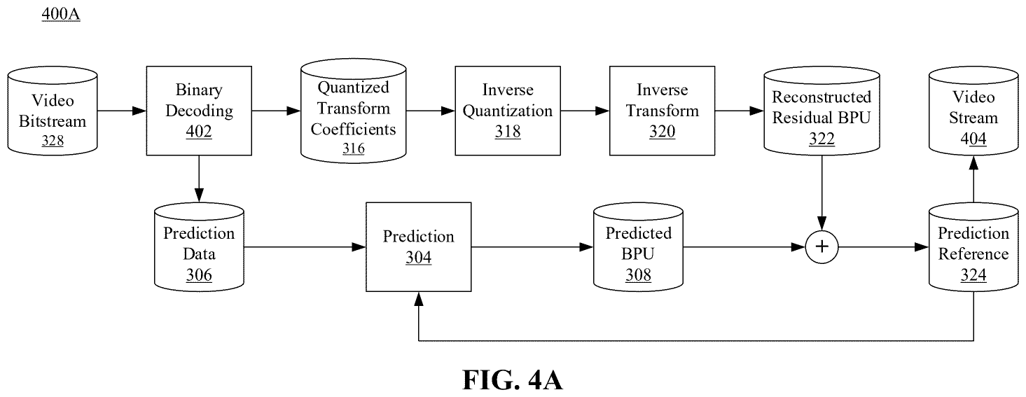

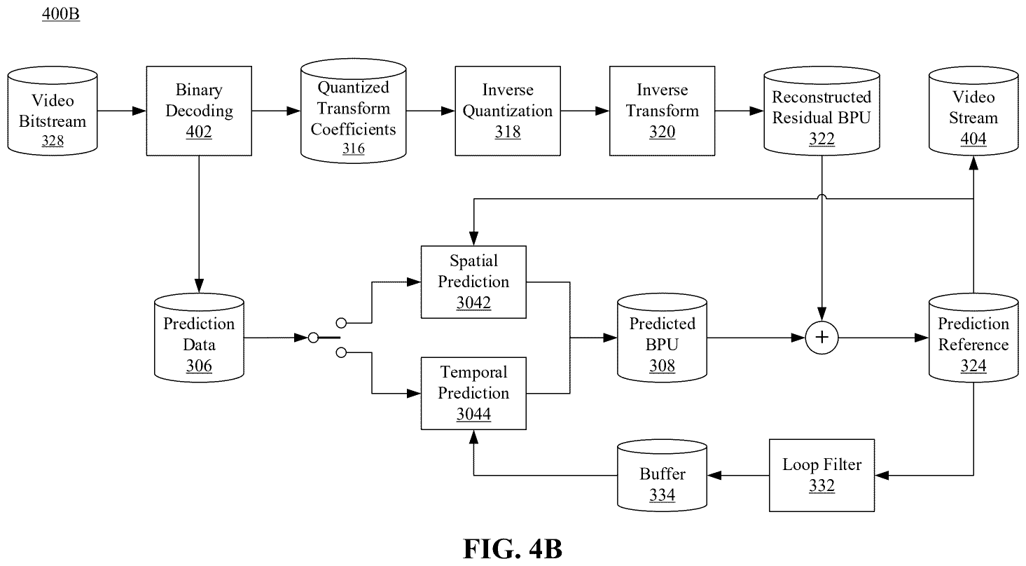

Video coding has multiple stages of operations, examples of which are shown in FIGS. 3A-3B and FIGS. 4A-4B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, H.264/AVC, or AVS), or as “coding units” (“CUs”) in some other video coding standards (e.g., H.265/HEVC, H.266/VVC, or AVS). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 3B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC, H.266/VVC, or AVS), and decide a prediction type for each individual basic processing sub-unit.

For another example, at a prediction stage (an example of which is shown in FIGS. 3A-3B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC, H.266/VVC, or AVS), at the level of which the prediction operation can be performed.

For another example, at a transform stage (an example of which is shown in FIGS. 3A-3B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC, H.266/VVC, or AVS), at the level of which the transform operation can be performed. It should be noted that the division schemes of the same basic processing sub-unit can be different at the prediction stage and the transform stage. For example, in H.265/HEVC, H.266/VVC, or AVS, the prediction blocks and transform blocks of the same CU can have different sizes and numbers.

FIG. 3A illustrates a schematic diagram of an example encoding process 300A, consistent with embodiments of the disclosure. For example, the encoding process 300A can be performed by an encoder. As shown in FIG. 3A, the encoder can encode video sequence 302 into video bitstream 328 according to process 300A. Similar to video sequence 200 in FIG. 2, video sequence 302 can include a set of pictures (referred to as “original pictures”) arranged in a temporal order. Similar to structure 210 in FIG. 2, each original picture of video sequence 302 can be divided by the encoder into basic processing units, basic processing sub-units, or regions for processing. In some embodiments, the encoder can perform process 300A at the level of basic processing units for each original picture of video sequence 302. For example, the encoder can perform process 300A in an iterative manner, in which the encoder can encode a basic processing unit in one iteration of process 300A. In some embodiments, the encoder can perform process 300A in parallel for regions (e.g., regions 214-218) of each original picture of video sequence 302.

In FIG. 3A, the encoder can feed a basic processing unit (referred to as an “original BPU”) of an original picture of video sequence 302 to prediction stage 304 to generate prediction data 306 and predicted BPU 308. The encoder can subtract predicted BPU 308 from the original BPU to generate residual BPU 310. The encoder can feed residual BPU 310 to transform stage 312 and quantization stage 314 to generate quantized transform coefficients 316. The encoder can feed prediction data 306 and quantized transform coefficients 316 to binary coding stage 326 to generate video bitstream 328. Components 302, 304, 306, 308, 310, 312, 314, 316, 326, and 328 can be referred to as a “forward path.” During process 300A, after quantization stage 314, the encoder can feed quantized transform coefficients 316 to inverse quantization stage 318 and inverse transform stage 320 to generate reconstructed residual BPU 322. The encoder can add reconstructed residual BPU 322 to predicted BPU 408 to generate prediction reference 324, which is used in prediction stage 304 for the next iteration of process 300A. Components 318, 320, 322, and 324 of process 300A can be referred to as a “reconstruction path.” The reconstruction path can be used to ensure that both the encoder and the decoder use the same reference data for prediction.

The encoder can perform process 300A iteratively to encode each original BPU of the original picture (in the forward path) and generate predicted reference 324 for encoding the next original BPU of the original picture (in the reconstruction path). After encoding all original BPUs of the original picture, the encoder can proceed to encode the next picture in video sequence 302.

Referring to process 300A, the encoder can receive video sequence 302 generated by a video capturing device (e.g., a camera). The term “receive” used herein can refer to receiving, inputting, acquiring, retrieving, obtaining, reading, accessing, or any action in any manner for inputting data.

At prediction stage 304, at a current iteration, the encoder can receive an original BPU and prediction reference 324, and perform a prediction operation to generate prediction data 306 and predicted BPU 308. Prediction reference 324 can be generated from the reconstruction path of the previous iteration of process 300A. The purpose of prediction stage 304 is to reduce information redundancy by extracting prediction data 406 that can be used to reconstruct the original BPU as predicted BPU 308 from prediction data 406 and prediction reference 324.

Ideally, predicted BPU 308 can be identical to the original BPU. However, due to non-ideal prediction and reconstruction operations, predicted BPU 308 is generally slightly different from the original BPU. For recording such differences, after generating predicted BPU 308, the encoder can subtract it from the original BPU to generate residual BPU 310. For example, the encoder can subtract values (e.g., greyscale values or RGB values) of pixels of predicted BPU 308 from values of corresponding pixels of the original BPU. Each pixel of residual BPU 310 can have a residual value as a result of such subtraction between the corresponding pixels of the original BPU and predicted BPU 308. Compared with the original BPU, prediction data 306 and residual BPU 310 can have fewer bits, but they can be used to reconstruct the original BPU without significant quality deterioration. Thus, the original BPU is compressed.

To further compress residual BPU 310, at transform stage 312, the encoder can reduce spatial redundancy of residual BPU 310 by decomposing it into a set of two-dimensional “base patterns,” each base pattern being associated with a “transform coefficient.” The base patterns can have the same size (e.g., the size of residual BPU 310). Each base pattern can represent a variation frequency (e.g., frequency of brightness variation) component of residual BPU 310. None of the base patterns can be reproduced from any combinations (e.g., linear combinations) of any other base patterns. In other words, the decomposition can decompose variations of residual BPU 310 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 312, such as, for example, a discrete cosine transform, a discrete sine transform, or the like. The transform at transform stage 312 is invertible. That is, the encoder can restore residual BPU 310 by an inverse operation of the transform (referred to as an “inverse transform”). For example, to restore a pixel of residual BPU 310, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 310 without receiving the base patterns from the encoder. Compared with residual BPU 310, the transform coefficients can have fewer bits, but they can be used to reconstruct residual BPU 310 without significant quality deterioration. Thus, residual BPU 310 is further compressed.

The encoder can further compress the transform coefficients at quantization stage 314. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 314, the encoder can generate quantized transform coefficients 316 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 316, by which the transform coefficients are further compressed. The quantization process is also invertible, in which quantized transform coefficients 316 can be reconstructed to the transform coefficients in an inverse operation of the quantization (referred to as “inverse quantization”).

Because the encoder disregards the remainders of such divisions in the rounding operation, quantization stage 314 can be lossy. Typically, quantization stage 314 can contribute the most information loss in process 300A. The larger the information loss is, the fewer bits the quantized transform coefficients 316 can need. For obtaining different levels of information loss, the encoder can use different values of the quantization parameter or any other parameter of the quantization process.

At binary coding stage 326, the encoder can encode prediction data 306 and quantized transform coefficients 316 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 306 and quantized transform coefficients 316, the encoder can encode other information at binary coding stage 326, such as, for example, a prediction mode used at prediction stage 304, parameters of the prediction operation, a transform type at transform stage 312, parameters of the quantization process (e.g., quantization parameters), an encoder control parameter (e.g., a bitrate control parameter), or the like. The encoder can use the output data of binary coding stage 326 to generate video bitstream 328. In some embodiments, video bitstream 328 can be further packetized for network transmission.

Referring to the reconstruction path of process 300A, at inverse quantization stage 318, the encoder can perform inverse quantization on quantized transform coefficients 316 to generate reconstructed transform coefficients. At inverse transform stage 320, the encoder can generate reconstructed residual BPU 322 based on the reconstructed transform coefficients. The encoder can add reconstructed residual BPU 322 to predicted BPU 308 to generate prediction reference 324 that is to be used in the next iteration of process 300A.

It should be noted that other variations of the process 300A can be used to encode video sequence 302. In some embodiments, stages of process 300A can be performed by the encoder in different orders. In some embodiments, one or more stages of process 300A can be combined into a single stage. In some embodiments, a single stage of process 300A can be divided into multiple stages. For example, transform stage 312 and quantization stage 314 can be combined into a single stage. In some embodiments, process 300A can include additional stages. In some embodiments, process 300A can omit one or more stages in FIG. 3A.

FIG. 3B illustrates a schematic diagram of another example encoding process 300B, consistent with embodiments of the disclosure. Process 300B can be modified from process 300A. For example, process 300B can be used by an encoder conforming to a hybrid video coding standard (e.g., H.26x series). Compared with process 300A, the forward path of process 300B additionally includes mode decision stage 330 and divides prediction stage 304 into spatial prediction stage 3042 and temporal prediction stage 3044. The reconstruction path of process 300B additionally includes loop filter stage 332 and buffer 334.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 324 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 324 in the temporal prediction can include the coded pictures. The temporal prediction can reduce the inherent temporal redundancy of the pictures.

Referring to process 300B, in the forward path, the encoder performs the prediction operation at spatial prediction stage 3042 and temporal prediction stage 3044. For example, at spatial prediction stage 3042, the encoder can perform the intra prediction. For an original BPU of a picture being encoded, prediction reference 324 can include one or more neighboring BPUs that have been encoded (in the forward path) and reconstructed (in the reconstructed path) in the same picture. The encoder can generate predicted BPU 308 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 308. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 306 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 3044, the encoder can perform the inter prediction. For an original BPU of a current picture, prediction reference 324 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 322 to predicted BPU 308 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 2), it can be deemed that the matching region “moves” to the location of the original BPU as time goes by. The encoder can record the direction and distance of such a motion as a “motion vector.” When multiple reference pictures are used (e.g., as picture 206 in FIG. 2), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 406 can include, for example, locations (e.g., coordinates) of the matching region, the motion vectors associated with the matching region, the number of reference pictures, weights associated with the reference pictures, or the like.

For generating predicted BPU 308, the encoder can perform an operation of “motion compensation.” The motion compensation can be used to reconstruct predicted BPU 308 based on prediction data 306 (e.g., the motion vector) and prediction reference 324. For example, the encoder can move the matching region of the reference picture according to the motion vector, in which the encoder can predict the original BPU of the current picture. When multiple reference pictures are used (e.g., as picture 206 in FIG. 2), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 204 in FIG. 2 is a unidirectional inter-predicted picture, in which the reference picture (e.g., picture 202) precedes picture 204. Bidirectional inter predictions can use one or more reference pictures at both temporal directions with respect to the current picture. For example, picture 206 in FIG. 2 is a bidirectional inter-predicted picture, in which the reference pictures (e.g., pictures 204 and 208) are at both temporal directions with respect to picture 204.

Still referring to the forward path of process 300B, after spatial prediction 3042 and temporal prediction stage 3044, at mode decision stage 330, the encoder can select a prediction mode (e.g., one of the intra prediction or the inter prediction) for the current iteration of process 300B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 308 and predicted data 306.

In the reconstruction path of process 300B, if intra prediction mode has been selected in the forward path, after generating prediction reference 324 (e.g., the current BPU that has been encoded and reconstructed in the current picture), the encoder can directly feed prediction reference 324 to spatial prediction stage 3042 for later usage (e.g., for extrapolation of a next BPU of the current picture). The encoder can feed prediction reference 324 to loop filter stage 332, at which the encoder can apply a loop filter to prediction reference 324 to reduce or eliminate distortion (e.g., blocking artifacts) introduced during coding of the prediction reference 324. The encoder can apply various loop filter techniques at loop filter stage 332, such as, for example, deblocking, sample adaptive offsets, adaptive loop filters, or the like. The loop-filtered reference picture can be stored in buffer 334 (or “decoded picture buffer”) for later use (e.g., to be used as an inter-prediction reference picture for a future picture of video sequence 302). The encoder can store one or more reference pictures in buffer 334 to be used at temporal prediction stage 3044. In some embodiments, the encoder can encode parameters of the loop filter (e.g., a loop filter strength) at binary coding stage 326, along with quantized transform coefficients 316, prediction data 306, and other information.

FIG. 4A illustrates a schematic diagram of an example decoding process 400A, consistent with embodiments of the disclosure. Process 400A can be a decompression process corresponding to the compression process 300A in FIG. 3A. In some embodiments, process 400A can be similar to the reconstruction path of process 300A. A decoder can decode video bitstream 328 into video stream 404 according to process 400A. Video stream 404 can be very similar to video sequence 302. However, due to the information loss in the compression and decompression process (e.g., quantization stage 314 in FIGS. 3A-3B), generally, video stream 404 is not identical to video sequence 302. Similar to processes 300A and 300B in FIGS. 3A-3B, the decoder can perform process 400A at the level of basic processing units (BPUs) for each picture encoded in video bitstream 428. For example, the decoder can perform process 400A in an iterative manner, in which the decoder can decode a basic processing unit in one iteration of process 400A. In some embodiments, the decoder can perform process 400A in parallel for regions (e.g., regions 214-218) of each picture encoded in video bitstream 328.

In FIG. 4A, the decoder can feed a portion of video bitstream 328 associated with a basic processing unit (referred to as an “encoded BPU”) of an encoded picture to binary decoding stage 402. At binary decoding stage 402, the decoder can decode the portion into prediction data 306 and quantized transform coefficients 316. The decoder can feed quantized transform coefficients 316 to inverse quantization stage 318 and inverse transform stage 320 to generate reconstructed residual BPU 322. The decoder can feed prediction data 306 to prediction stage 304 to generate predicted BPU 308. The decoder can add reconstructed residual BPU 322 to predicted BPU 308 to generate predicted reference 324. In some embodiments, predicted reference 324 can be stored in a buffer (e.g., a decoded picture buffer in a computer memory). The decoder can feed predicted reference 324 to prediction stage 304 for performing a prediction operation in the next iteration of process 400A.

The decoder can perform process 400A iteratively to decode each encoded BPU of the encoded picture and generate predicted reference 324 for encoding the next encoded BPU of the encoded picture. After decoding all encoded BPUs of the encoded picture, the decoder can output the picture to video stream 404 for display and proceed to decode the next encoded picture in video bitstream 328.

At binary decoding stage 402, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 306 and quantized transform coefficients 316, the decoder can decode other information at binary decoding stage 402, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 328 is transmitted over a network in packets, the decoder can depacketize video bitstream 328 before feeding it to binary decoding stage 402.

FIG. 4B illustrates a schematic diagram of another example decoding process 400B, consistent with embodiments of the disclosure. Process 400B can be modified from process 400A. For example, process 400B can be used by a decoder conforming to a hybrid video coding standard (e.g., H.26x series). Compared with process 400A, process 400B additionally divides prediction stage 304 into spatial prediction stage 3042 and temporal prediction stage 3044, and additionally includes loop filter stage 332 and buffer 334.

In process 400B, for an encoded basic processing unit (referred to as a “current BPU”) of an encoded picture (referred to as a “current picture”) that is being decoded, prediction data 306 decoded from binary decoding stage 402 by the decoder can include various types of data, depending on what prediction mode was used to encode the current BPU by the encoder. For example, if intra prediction was used by the encoder to encode the current BPU, prediction data 306 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 306 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 3042 or a temporal prediction (e.g., the inter prediction) at temporal prediction stage 3044. The details of performing such spatial prediction or temporal prediction are described in FIG. 3B and will not be repeated hereinafter. After performing such spatial prediction or temporal prediction, the decoder can generate predicted BPU 308. The decoder can add predicted BPU 308 and reconstructed residual BPU 322 to generate prediction reference 324, as described in FIG. 4A.

In process 400B, the decoder can feed predicted reference 324 to spatial prediction stage 3042 or temporal prediction stage 3044 for performing a prediction operation in the next iteration of process 400B. For example, if the current BPU is decoded using the intra prediction at spatial prediction stage 3042, after generating prediction reference 324 (e.g., the decoded current BPU), the decoder can directly feed prediction reference 324 to spatial prediction stage 3042 for later usage (e.g., for extrapolation of a next BPU of the current picture). If the current BPU is decoded using the inter prediction at temporal prediction stage 3044, after generating prediction reference 324 (e.g., a reference picture in which all BPUs have been decoded), the decoder can feed prediction reference 324 to loop filter stage 332 to reduce or eliminate distortion (e.g., blocking artifacts). The decoder can apply a loop filter to prediction reference 324, in a way as described in FIG. 3B. The loop-filtered reference picture can be stored in buffer 334 (e.g., a decoded picture buffer in a computer memory) for later use (e.g., to be used as an inter-prediction reference picture for a future encoded picture of video bitstream 328). The decoder can store one or more reference pictures in buffer 334 to be used at temporal prediction stage 3044. In some embodiments, prediction data can further include parameters of the loop filter (e.g., a loop filter strength). In some embodiments, prediction data includes parameters of the loop filter when the prediction mode indicator of prediction data 306 indicates that inter prediction was used to encode the current BPU.

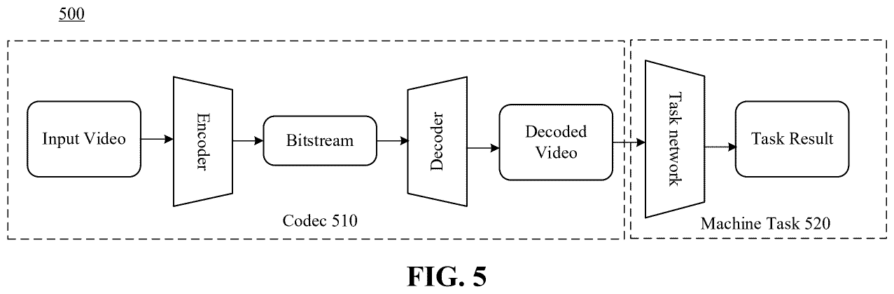

Driven by the development of in multimedia collection, processing, and display devices, visual data has explosively grown. Therefore, the compression of visual signals is more and more important. The main task of the existing codecs is to seek better reconstructed signal quality with limited bitrate constraint. Due to the remarkable success of deep learning in various visual analysis and understanding tasks, the deep learning models of visual information are widely used. FIG. 5 is a schematic diagram illustrating an exemplary machine-oriented video compression framework 500, according to some embodiments of the present disclosure. As shown in FIG. 5, machine-oriented video compression framework 500 includes a codec module 510 and a machine task processing module 520. Codec module 510 may include processes 300A, 300B, 400A and 400B shown in FIG. 3 and FIG. 4. Machine task processing module 520 may include task networks (e.g., deep learning models) to process the decoded video output from codec module 510.

Model based Compression (MBC) focuses on modelling and coding the structural visual information in the images and videos. The image content can be divided into textures and edges, and coded by different approaches, e.g. using statistical coding methods for textures and visual model-based coding methods for edges, which was the predecessor of the human visual system (HVS) model-based perceptual coding methods. The term “model” in MBC is explained as object-related models and developed from the source model in signal processing. A video sequence containing one or more moving objects is analysed to yield information about the size, location, and motion of the objects, which is employed to synthesize a model of each object as animation data. The animation data are coded and transmitted to the decoder. Moreover, the residual pixel data, comprising the difference between the original video sequence and the sequence derived from the animated model, are also transmitted to the decoder. The decoder adopts the animation data to synthesize the model, which is subsequently accompanied by the residual pixel data to reconstruct the image sequence. MBC may include pixel MBC, block motion MBC, and object MBC, i.e., the first-generation and second-generation methods. Consistent with the disclosed embodiments, MBC classification can be used to present the historical development of the model from the signal source to the object and the content understanding of the objects. It is observed that the evolution of MBC, from the statistical pixel and block to the geometric partition and structural segmentation, and from the content-aware object to the understanding of the content including knowledge, semantics, and the knowledge of HVS. Moreover, many coding standards based on MBC have been developed, such as MPEG-4/7.

Consistent with the disclosed embodiments, learning based compression (LBC) can be used. MBC relies on manually designed modules where the components are heavily engineered to fit together. Such a design results in the structure of the signal being manually engineered and thus the capability of MBC to eliminate the redundancy is limited. With similar components to MBC, LBC models can be trained using massive image and video samples to determine the coding strategy automatically and alleviate the dependence on manually designed coding paradigms based on expert knowledge. With an automatic coding strategy, LBC enables the structure to be automatically discovered to eliminate redundancy more efficiently, which displays the great potential to achieve a better coding performance. In general, the similarity between MBC and LBC is that they share similar components to remove the redundancy in the signal, and the difference is that MBC relies on manually designed modules and LBC relies on a data-driven strategy or modules using machine learning. Numerous LBC approaches have been proposed for coding. LBC can be grouped into three categories: statistical learning, sparse representation, and deep learning-based methods.

Statistical learning is incorporated into image/video compression to reduce coding complexity or improve the compression performance, such as support vector machine (SVM), Bayesian decision, random forest, decision tree, and AdaBoost. SVM was used as a classifier to determine the early splitting or pruning of a coding unit (CU). The Bayesian decision rule was employed with skip states to early terminate the binary-tree (BT) and extended quad-tree (EQT) partition. A random forest classifier was used to determine the most likely partition modes. A fast-intra-coding scheme was proposed where a low complexity coding tree unit (CTU) structure was derived with a decision tree, and the optimal intra mode was decided with the gradient descent principle. AdaBoost is incorporated as a classifier for CU partition determination. Although these methods are data-driven to discover the best strategy for compression, they are adopted as complex classifiers using manually designed features for coding standards and thus are limited to the scarcity of generalization caused by manually designed features.

A sparse representation of a signal consists of a linear combination of relatively few base elements in a basis or an overcomplete dictionary. Signals that are represented sparsely are termed compressible under the learnable dictionary. Learning dictionaries is researched to adapt to a signal class for image compression. A K-SVD (singular value decomposition) dictionary-based facial image codec is applied. K-SVD dictionaries are trained for predefined image patches. The encoding is based on sparse coding of each image patch with the trained dictionary, and the decoding is a simple reconstruction of the patches by the linear combination of atoms. A concatenation of orthogonal bases is adopted as the dictionary, where each basis is selected to encode any given image block of fixed size. An iteration-tuned and aligned dictionary (ITAD)-based image codec is proposed for particular image classes, such as facial images. ITAD is used as a transformation to code image blocks taken over a regular grid. Although some encouraging results were achieved, sparse representation-based coding is designed for particular image classes due to the nature of sparse representation, and thus hard to generalize to wild images encountered in practical scenarios.

Furthermore, neural networks have been widely explored in image/video coding, which is termed deep learning-based coding. Deep learning-based coding has some advantages over statistical learning and sparse representation-based coding. First, neural networks can mine the underlying characteristics of data and exploit the spatial correlation of textural content, and learn the features adaptively rather than manually designed features. Second, with massive training data, deep learning-based coding can be generalized to wild images and videos.

Multilayer perceptron (MLP) includes an input layer of neurons, several hidden layers of neurons, and an output layer of neurons. This structure provides evidence for scenarios such as dimension reduction and data compression. An end-to-end image compression framework based on the compact representation of the neural network and leveraging high parallelism is proposed. A fully connected network is trained to compress each 8×8 patch of the input image with back propagation. A dimension-reduction network is proposed to compress the image. In addition, the framework used quantization and entropy coding as individual modules. Furthermore, the MLP-based predictive image coding algorithm is used to exploit the spatial context information. To reduce training time, the nested training algorithm (NTA) was proposed for image compression with an MLP-based hierarchical neural network. A new class of random neural networks is proposed. Different from MLP, signals in random neural network methods are in the spatial domain. The combination of the random neural network and image compression is also considered. A random neural network is proposed to apply in the image compression task, which is further improved in by integrating the wavelet domain of images. The recurrent neural network (RNN) includes a class of neural networks with memory modules to store recent information. An RNN-based image compression framework is proposed to utilize a scaled-additive module for coding. A spatially adaptive image compression framework that divided the image into tiles for better coding efficiency is also proposed.

With the development of CNNs, many deep learning-based frameworks outperform traditional algorithms in both low-level and high-level computer vision tasks. Under the scalar quantization assumption, an end-to-end optimized neural framework for image compression based on CNNs is proposed. During training, An i.i.d uniform noise is added to simulate the quantized operation and replace the stochastic gradient descent approach to avoid zero derivatives. The joint rate-distortion optimization problem can be cast in the context of variational auto-encoders (VAE). The compression model is extended by using scale hyperpriors for entropy estimation, which achieved better performance compared with HEVC. The context model of entropy coding is enhanced for end-to-end optimized image compression. Discretized Gaussian mixture likelihoods and attention modules are proposed to further improve the performance.

Generative adversarial networks (GAN) are developing rapidly in the application of deep neural networks. It has been proposed to use an integrated and well-optimized GAN-based image compression. Inspired by the advances in GAN-based view synthesis, light field (LF) image compression can achieve significant coding gain by generating the missing views using the sampled context views in LF. In addition, a homogeneous deep generative model deep recurrent attentive writer (DRAW) is proposed for coding framework. Conceptual compression by generating the image semantic information as much as possible is also studied. An extreme image compression system using unconditional and conditional GANs is proposed, outperforming all other codecs under low bit-rate conditions. Learned perceptual image patch similarity (LPIPS) is proposed as the metric for generator training, which further improves the subjective quality of the reconstructed image.

Recently, end-to-end image compression has developed exponentially due to the promising representation capability for visual signal. The core concept is to transform the image into the latent code using deep neural network, leading to compact, effective and perceptually meaningful representations. An end-to-end image compression framework using generalized divisive normalization (GDN) is proposed, and the entire framework is optimized with rate-distortion optimization (RDO). The concept of hyperprior which captures spatial dependencies in latent representation is introduced, which led to the better visual quality with less coding bits. Generally, continuous rate control can adapt to different network environments better. Motivated by this, a new autoencoder called Gained Variable Autoencoder (G-VAE) is proposed. More specifically, a pair of gain units are incorporated into the end-to-end image compression framework, leading to continuous variable rate compression without increasing network parameter and computational cost. A new variable rate image compression framework and conditional automatic encoder are proposed, where the structure of conditional fluctuation and universal quantification are employed. The end-to-end compression framework based on deep learning (Deep Video Compression framework (DVC) and Multiple frames prediction for Learned Video Compression (M-LVC)), have also been developed.

Various methods for machine vision-oriented video coding are proposed, mainly including visual signal compression and compact feature representation. In recent years, video data has dominated internet traffic and has become one of the major data formats. With the emerging 5G and internet of things (IoT) technologies, more and more videos are generated by edge devices, sent across networks, and consumed by machines. The volume of video consumed by machine is exceeding the volume of video consumed by humans. Machine vision tasks include object detection, segmentation, tracking, and other machine-based applications, which are quite different from those for human consumption. On the other hand, due to large volumes of video data, it is essential to compress video before transmission. Thus, efficient video coding for machines (VCM) has become an important topic.

Video data has become the largest source of data consumed globally. There is a growing awareness that the majority of video traffic will be used by machines. Today's societies are becoming ever more multimedia-centric, data-dependent, and automated. Automation, analysis, and intelligence is moving beyond humans to “machine-specific” applications, creating the need for machine-to-machine (M2M) or machine-to-human (M2H) communications. The rise of AI-driven video intelligent solutions, such as video coding for machine (VCM) standards for M2M or M2H vision, will be key solutions addressing the most severe challenges of multimedia computing, transmission, and storage. VCM will be transforming everyday video content by identifying, classifying, and indexing objects that appear within, so that the metadata becomes machine specific, searchable, and actionable. It is expected that the trend will continue due to the convergence of emerging technologies such as 5G, artificial intelligence (AI), smart sensors, the internet of things (IoT), and connected and autonomous vehicles. The switch to AI-enabled 5G networks is happening now and is aiming to transform smart cities, the automotive industry, and intelligent transportation systems (ITS). Additionally, more and more edge devices can capture video signals, which are sent across either internet or private networks and consumed by machines for analysis. The emerging VCM standard can help mainstream visual data applications to broaden their use cases in the areas of autonomous cars, smart cities, smart sensors, intelligent industry, immersive entertainment, and beyond. In most of these use cases, certain portions of videos are mainly used for machine-vision tasks such as image classification, object detection, segmentation, tracking, or similar applications. In some other use cases such as surveillance, humans may occasionally inspect some of the videos to extract additional information that is not captured by machines. Due to the huge volume of video data, video coding technologies have been employed to compress videos before transmission or storage. Traditionally video is consumed by human beings for a variety of usages such as entertainment, education, etc. Thus, video coding often utilizes characteristics of the human visual system (HVS) for better compression efficiency while maintaining good subjective quality. For example, the popular video coding standards, such as MPEG2, H.264/AVC, H.265/HEVC, and the recently finalized H.266/Versatile Video Coding (VVC), all follow this design principle.

Machine vision tasks are different from human vision tasks with different purposes and evaluation metrics. How to encode video for machine consumption becomes a challenging problem. An Ad-Hoc group so-called Video Coding for Machines (VCM) is founded under the international standard organization MPEG, which also developed the popular video coding standards mentioned above.

The mandate of the MPEG VCM group can be summarized as follows: (1) Define use cases and related requirements for compression for machine vision and hybrid human/machine visions; (2) Collect dataset with ground truth and evaluation metrics; (3) Solicit technology evidence for feature compression, combined human/machine-oriented video representation and compression; (4) Develop a framework to evaluate and compare different technology solutions. (5) Develop the standards for video coding for machines.

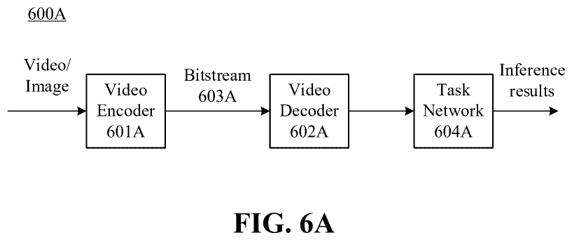

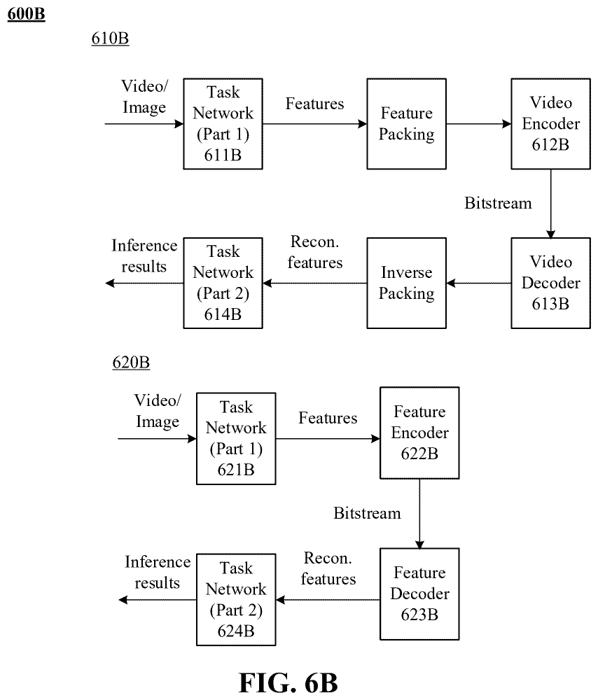

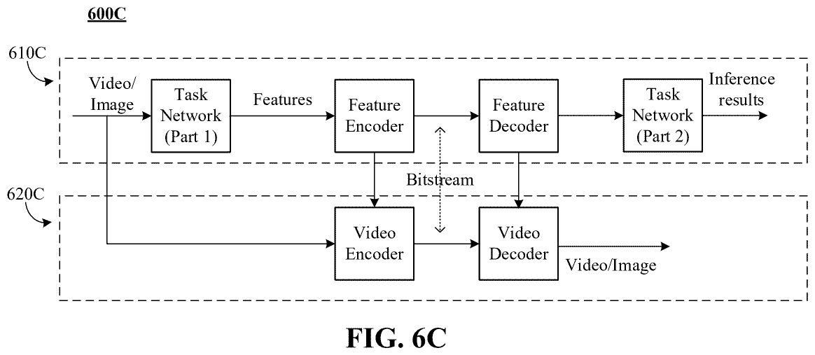

The VCM group focuses on the uses cases that require compression of a video or features extracted from a video. FIGS. 6A-6C illustrate three exemplary video coding for machines (VCM) processing frameworks respectively, according to some embodiments of the present disclosure.

FIG. 6A shows an exemplary VCM processing framework 600A. Referring to FIG. 6A, video codecs (e.g., a video encoder 601A and a video decoder 602A) are used to compress videos before transmission or storage and decompress the generated bitstreams 603A into videos for consumption by machine analysis devices (e.g., a task network 604A). There is no restriction on the architecture of the video codec, which can follow the traditional hybrid block-based codec or deep learning-based codec that optimized for machine vision or hybrid human and machine vision. It can be noted that in some embodiments, VVC is used as the codec.

FIG. 6B shows another exemplary VCM processing framework 600B. Referring to FIG. 6B, the neural network for a machine vision task is split into two parts. Task network (Part 1) is at edge devices that contain image sensors or video cameras. Task network (Part 2) is configured to generate machine task inference results. There are two alternative approaches. Framework 610B illustrates an approach to pack the output features of task network (Part 1) 611B into images or videos which are compressed by video encoders 612B. The generated bitstreams are transmitted to servers through networks. At the server-side, video decoders 613B decode the bitstream to generate reconstructed images/videos which are inversely packed into reconstructed features used as input to the task network (Part 2) 624B. Framework 620B illustrates another approach. feature encoders 622B directly encode the features, output from task network (Part 1) 621B, according to their characteristics. The generated bitstreams are transmitted to servers through networks. Then, feature decoders 623B decode the bitstreams into features that are fed into task network (Part 2) 624B directly.

FIG. 6C shows another exemplary VCM processing framework 600C. Referring to FIG. 6C, framework 600C is configured to process cases of hybrid human and machine vision. A first branch 610C of framework 600C is a simplified version of framework 600B that compresses the intermediate features while a second branch 620C shows the encoding of the input video using a video encoder, which makes use of the raw video and the features extracted from the video as the inputs. This is different from the traditional video codec such as AVC, HEVC, or VVC. The video decoder at the second branch 620C utilizes the generated bitstream and the reconstructed features from the first branch 610C to reconstruct videos/images for human consumption.

For visual signal compression, a flexible and novel learned image compression (LIC) framework and the multi-scale progressive (MSP) probability model for lossy image compression are proposed. The framework takes the MSP probability model for lossy image compression which efficiently exploits the spatial-wise and channel-wise correlation of the latent representation and significantly reduces decoding complexity.

For feature compression, it is hindered by the following factors: models are usually adjusted for specific tasks, and top-layer features are very specific to tasks and difficult to promote. A new solution with feature compression of the intermediate layer is proposed. In practice, it provides a trade-off between traditional video coding and feature compression, as well as a good trade-off between computing load, communication cost and generalization capability. The intermediate layer features are compressed and transmitted instead of the original video or top layer features. End to end learning usually enables deep features to have a larger receptive field and more specific tasks. Therefore, compared with the depth features, the features from the shallow layer generally contain more information clues.

For processing machine tasks, a method that removes or blurs unimportant information before coding is proposed, and good results were obtained. To be specific, the method first obtains the segmentation mask of important objects, then removes part of the background according to the mask, and finally blurs the rest of the background. It is proposed to save the bitrate consumption and maintain the accuracy of the machine tasks by removing some of the irrelevant information in the image without modifying the codec and the downstream task network.

Although the general video compression architecture has high visual signal reconstruction capability, these methods also have some shortcomings in the machine task. Traditional and deep learning-based codecs prioritize signal fidelity over machine task performance, but this may not be suitable for machine vision applications. Some research has focused on improving video compression codecs or developing features for machine tasks. However, creating a new codec requires significant efforts. The existing video coding for machine is generally located in the cloud due to the computational cost required for machine tasks. As a user, the uploader can use less computing power and may not even be able to use a GPU. As such, using post-processing to consume computing power in the cloud would be better than pre-processing.

Some embodiments of the present disclosure provide a method and compression framework with post-processing for machine vision. For example, a post-processing network can be used to enhance semantic-related information without altering the existing codec. The post-processing network can be a quantization parameter (QP) adaptive visual signal enhancement network for post-processing to improve machine task performance. In some embodiments, instead of using QP, the enhancement network can use other information formats such as constant rate factor or bitrate.

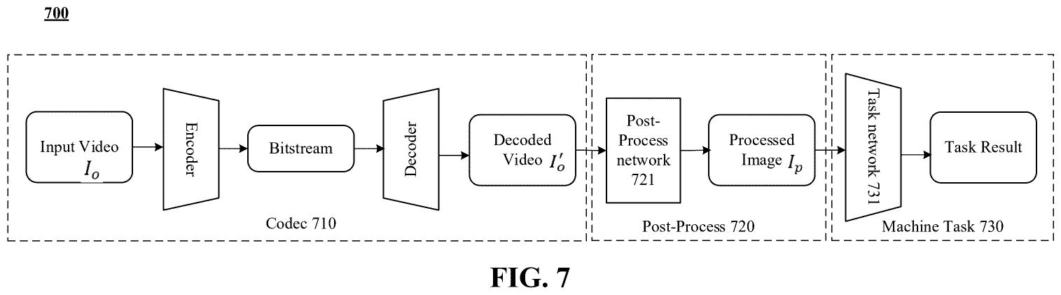

FIG. 7 is a schematic diagram illustrating an exemplary framework 700 of visual signal compression for machine task, according to some embodiments of the present disclosure. As shown in FIG. 7, framework 700 includes a codec module 710 for transmitting an input visual signal to a reconstructed visual signal, a post-processing module 720 for enhancing the reconstructed visual signal, and a machine task module 730 is used as an ultimate receiver. Codec module 710 further includes an encoder 711 and a decoder 712 to perform encoding and decoding processes (such as processes 300A, 300B, 400A and 400B shown in FIGS. 3A, 3B, 4A, and 4B). An original visual signal Iₒ is compressed and reconstructed as a reconstructed visual signal Iₒ′ with codec module 710. Post-processing module 720 includes a post-processing network 721 to obtain a post-processed visual signal Iₚ based on the Iₒ′. Post-processing network 721 enhances semantic-related information without altering the existing codec. Machine task module 730 may include task networks 731 to process the post-processed visual signal Iₚ from post-processing module 720.

In some embodiments, the post-processing module 720 includes a QP adaptive post-processing network [symbol] ₚₒₛₜ(⋅), e.g., post-processing network 721 is the QP adaptive post-processing network. Then, post-processing network 721 could learn the distortion of the codec and enhance the machine vision performance. In some embodiments, the quantization parameter [symbol] can be replaced by other information parameter to represent the codec compression ratio, for example, the quantization parameter [symbol] can be replaced by Constant Rate Factor (CRF) or Bitrate. In some embodiments, additional information, such as quantification parameter, CRF, or bitrate, is not required to improve the visual signal.

In some embodiments, post-processing network 721 may include various visual signal post-processing networks or visual signal enhancement operations. For example, post-processing network 721 can be Video Restoration with Enhanced Deformable Convolutional Networks (EDVR), Multi-Frame Quality Enhancement for Compressed Video, or Basic VSR++ (improving video super-resolution with enhanced propagation and alignment).

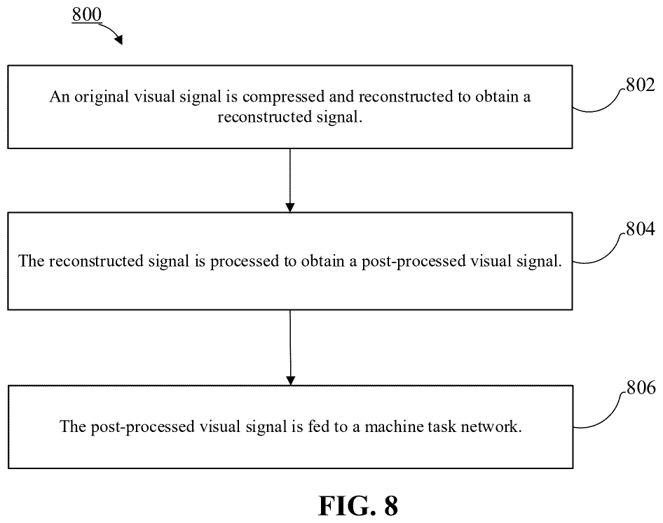

FIG. 8 illustrates an exemplary flowchart of a video processing method 800, according to some embodiments of the present disclosure. Method 800 can be performed by a framework (e.g., by framework 700 of FIG. 7). Referring to FIG. 7 and FIG. 8, method 800 includes steps 802 to 806.

In step 802, an original visual signal is compressed and reconstructed to obtain a reconstructed signal. For example, the original visual signal Iₒ is compressed and reconstructed to obtain a reconstructed signal Iₒ′ with the codec module 710 (e.g., an encoder 711 and a decoder 712).

In step 804, the reconstructed signal is processed to obtain a post-processed visual signal. For example, the reconstructed signal Iₒ′ is processed to obtain a post-proceed visual signal Iₚ by post-processing module 720. In some embodiments, the post-processed visual signal Iₚ is obtained based on the reconstructed signal I′ and a parameter indicating a compression ratio. For example, the parameter indicating the compression ratio can include a quantization parameter [symbol] , a constant rate factor (CFR), or a bitrate. Therefore, post-processed visual signal Iₚ is obtained based on the reconstructed signal Iₒ′ and the quantization parameter [symbol] , the constant rate factor (CFR), or the bitrate.

In step 806, the post-processed visual signal is fed to a machine task network. For example, the post-processed visual signal Iₚ is fed to machine task networks 731 in machine task module 730 of the application scenarios.

In some embodiments, distortion of the framework is learned to enhance the machine vision performance.

The loss of the compression framework is primarily characterized based on the coding bits and distortion between the input visual signal and reconstructed visual signal, which is the rate-distortion optimization (RDO). In some embodiments, loss functions can be used to enhance the machine vision performance. For the video coding for machine tasks, the task accuracy is included in the loss function based on the task required feature maps. As a result, the loss function [symbol] ₐₗₗ of the proposed framework (e.g., framework 700 of FIG. 7) includes four parts, and the loss function [symbol] ₐₗₗ is formulated as follows,

$${ℒ}_{all} = {λ}_{D} {ℒ}_{D} + {λ}_{F} {ℒ}_{F} \qquad ( 1 )$$

where [symbol] _{D} and [symbol] _{F} are the visual signal distortion loss and feature distortion loss, respectively. Meanwhile, the λ_{D} and λ_{F} are hyper-parameters of the weights for the corresponding loss.

Specifically, the feature distortion loss [symbol] _{F} is the feature distortion loss of the feature in machine task network (e.g., machine task network 731 of FIG. 7). In some embodiments, various methods, such as mean absolute error (MAE) or structural similarity index (SSIM), can be used to calculate the feature distortion loss [symbol] F.

In some embodiments, the machine task network (e.g., machine task network 731 in FIG. 7) is a Mask R-CNN (an extension of Faster R-CNN that adds a branch for predicting an object mask), and the corresponding feature map of the Mask R-CNN is used to generate feature distortion loss [symbol] _{F}. In some embodiments, a feature map from other network can be also used, for example, You Only Look Once (Yolo) model, Residual Networks (ResNet), or ResNeXt (Aggregated Residual Transformations for Deep Neural Networks).

The visual signal distortion loss [symbol] _{D} considers the mean squared error (MSE) loss of the original visual signal Iₒ and the post-processed visual signal Iₚ.

In some embodiments, these loss functions can be used individually or in combination.

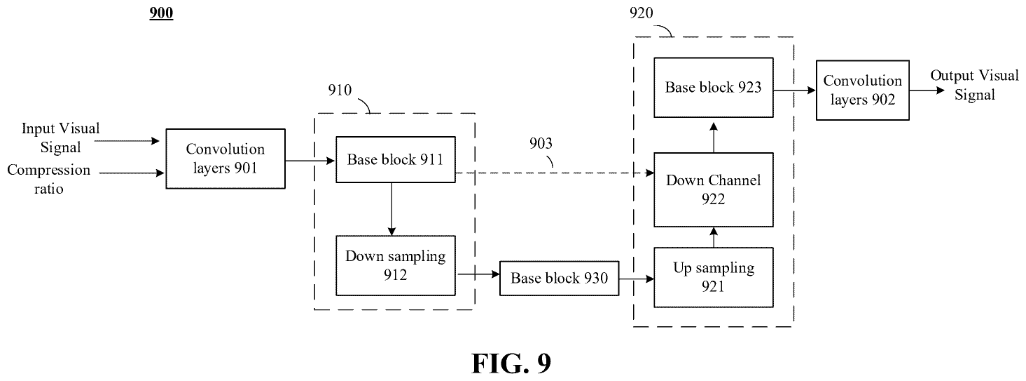

To adapt a compression ratio of codec, some embodiments of the present disclosure further provide a post-processing network to improve the rate-accuracy (RA) performance with compression. FIG. 9 is a schematic diagram illustrating an exemplary post-processing network 900, according to some embodiments of the present disclosure. As shown in FIG. 9, post-processing network 900 includes a feature down-sampling branch 910 and a feature up-sampling branch 920.

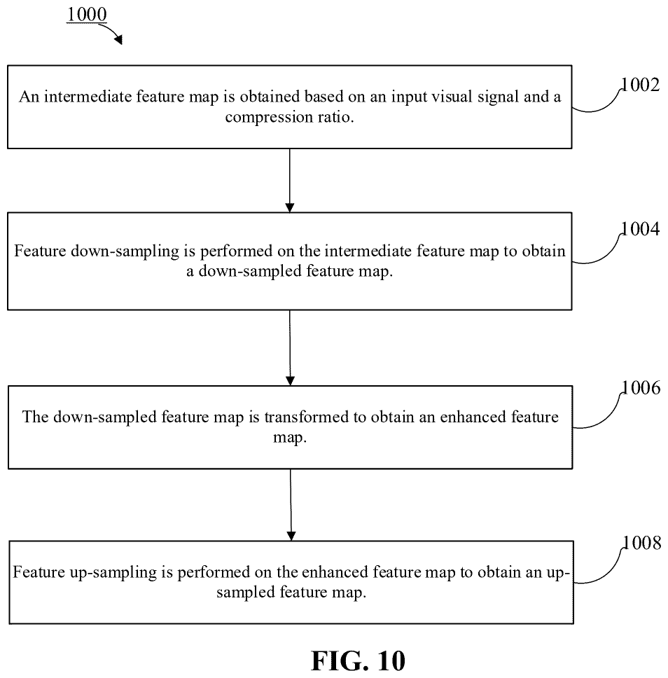

FIG. 10 illustrates an exemplary flowchart of a post-processing method 1000, according to some embodiments of the present disclosure. Method 1000 can be performed by a processing network (e.g., post-processing network 900 of FIG. 9). Details of post-processing network 900 will be described below and is consistent with method 1000. Referring to FIG. 9 and FIG. 10, method 1000 includes steps 1002 to 1008.

In step 1002, an intermediate feature map is obtained based on an input visual signal and a compression ratio. The intermediate feature map is used within post-processing network 900. In some embodiments, the compression ratio is represented by a parameter, for example, a quantization parameter [symbol] , a constant rate factor (CFR), or a bitrate. The compression ratio is designed to make post-processing network 900 focus on reconstruction distortion of different compression ratio and improve the RA performance. In some embodiments, the parameter indicating the compression ratio is expended to a same size of the input visual signal. In some embodiments, a channel size of a feature map of the input visual signal is increased by convolution layers 901, and the intermediate feature map is obtained based on the increased feature map. It can be understood that the input visual signal of post-processing network 900 is a reconstructed visual signal Iₒ′ output by a codec (e.g., codec module 710) as shown in FIG. 7.

In step 1004, feature down-sampling is performed on the intermediate feature map to obtain a down-sampled feature map. In some embodiments, the intermediate feature map is enhanced to obtain an enhanced intermediate feature map by a base block 911 and the enhanced intermediate feature map is down-sampled by a down-sampling block 912 to obtain the down-sampled feature map. Down-sampling block 912 is configured to down-sample feature map. In some embodiments, down-sampling block 912 includes a max pooling layer, for example, a max pooling layer with kernel size 2. In some embodiments, the feature down-sampling includes one or more layers. For example, feature down-sampling branch 910 includes a plurality of base blocks 911 and down-sampling block 912 in series. A current down-sampled feature map obtained by a current feature down-sampling is used as an input feature map for a next feature down-sampling.

In step 1006, the down-sampled feature map is transformed to obtain an enhanced feature map. In some embodiments, the down-sampled feature map is enhanced by a base block 930 to obtain the enhanced feature map.

In step 1008, feature up-sampling is performed on the enhanced feature map to obtain an up-sampled feature map. For example, the enhanced feature map is up-sampled by an up-sampling block 921 to obtain the up-sampled feature map. Up-sampling block 921 is configured to up-sample feature maps. In some embodiments, up-sampling block 921 includes a deconvolution layer with an upscaling factor of 2. An output visual signal is obtained based on the up-sampled feature map. For example, the up-sampled feature map is processed by convolution layers 902 to obtain the output visual signal. It can be understood that the output visual signal can be post-processed visual signal Iₚ as shown in FIG. 7. In some embodiments, the up-sampled feature map is further enhanced to obtain an enhanced up-sampled feature map by a base block 923, and the output visual signal is obtained based on the enhanced up-sampled feature map. In some embodiments, the feature up-sampling includes one or more layers, corresponding to the layers of feature down-samplings. The layer number of feature up-samplings and the layer number of feature down-samplings are the same, for example, in a range of 1 to 4. For example, feature up-sampling branch 920 includes a plurality of up-sampling blocks 921 and base blocks 923 in series. A current enhanced up-sampled feature map obtained by a current feature up-sampling is used as an input feature map for a next feature up-sampling.

In some embodiments, base blocks 911, 930, and 923 can be baseline blocks in a visual signal restoration network and configured to improve visual signal enhancement performance. In some embodiments, base blocks 911, 930, and 923 include Nonlinear Activation Free network (NAFNet) for image restoration, Residual Networks (ResNet), or Densely connected convolutional network (DenseNet).

To process the input visual signal effectively at a pixel level, in some embodiments, a promising U-Net architecture with parallel mirrored skip connections is applied. Still referring to FIG. 9 and FIG. 10, in step 1008, the enhanced feature map is up-sampled to obtain an intermediate up-sampled feature map, the intermediate up-sampled feature map and the enhanced intermediate feature map are combined, and a channel size of the combination is reduced to obtain the up-sampled feature map. For example, the enhanced feature map is up-sampled by up-sampling module 921 to obtain the intermediate up-sampled feature map, the enhanced intermediate feature map from base block 911 is copied to feature up-sampling branch 920 by skip connection 903. The intermediate up-sampled feature map and enhanced intermediate feature map are combined, and a channel size of the combination is reduced by a down channel block 922 to obtain the up-sampled feature map. Down channel block 922 is configured to reduce a channel size of a feature map, for example, down channel block 922 includes a convolution layer with kernel size 1. In this example, up-sampling block 921 includes a deconvolution layer and pixel shuffle function with an upscaling factor of 2.

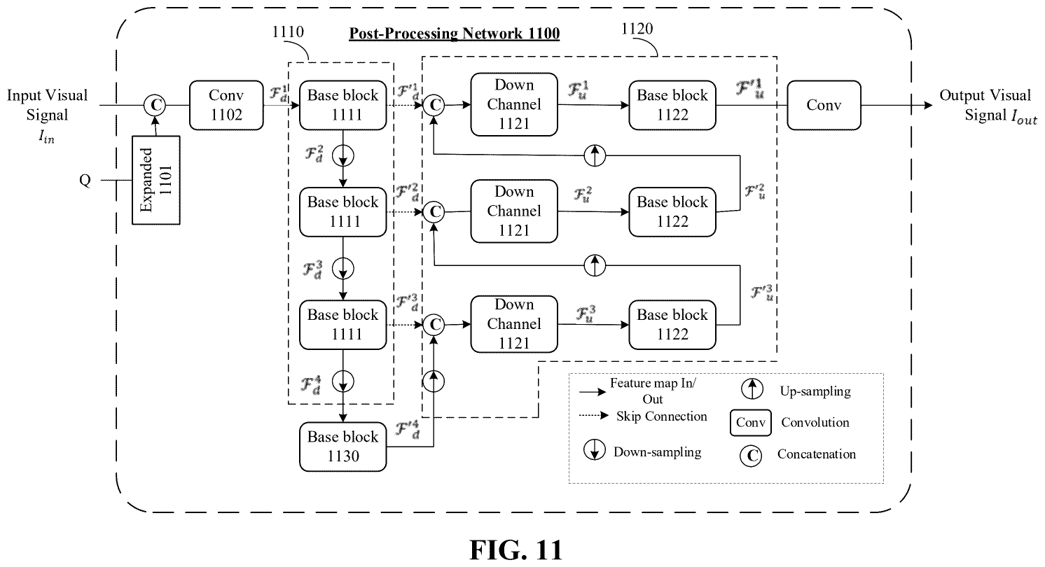

FIG. 11 is a schematic diagram illustrating another exemplary post-processing network 1100, according to some embodiments of the present disclosure. As shown in FIG. 11, post-processing network 1100 includes a feature down-sampling branch 1110 and a feature up-sampling branch 1120.

In feature down-sampling branch 1110, an input visual signal Iᵢₙ and a quantization parameter (QP) [symbol] are input to post-processing network 1100. To adapt the QP, the [symbol] is expanded to the same size as the input visual signal Iᵢₙ by an expanded block 1101 and concatenated with the input visual signal Iᵢₙ as an input to provide the codec quantization information. In some embodiments, the concatenation operation could be replaced by multiplication or addition operations. The channel size of a feature map of the input visual signal Iᵢₙ is increased by a convolution layer 1102 to be suitable for following processing. As shown in FIG. 11, in this example, post-processing network 1100 includes three layers of samplings, i.e., post-processing network 1100 includes three layers of feature down-samplings and three layers of feature up-samplings. An intermediate feature map [symbol] _{d}¹ of a first resolution is extracted by an extraction block (not shown). Then, an intermediate feature map [symbol] _{d}ⁱ (e.g., [symbol] _{d}¹, [symbol] _{d}², and [symbol] _{d}³) is processed with base block 1111 to an enhanced feature map [symbol] ′_{d}ⁱ (e.g., [symbol] ′_{d}¹, [symbol] ′_{d}², and [symbol] ′_{d}³), which could enhance the features representation with an attention mechanism and feature adaptation with an adaption layer. Then, the enhanced feature map [symbol] ′_{d}ⁱ (e.g., [symbol] ′_{d}¹, [symbol] ′_{d}², and [symbol] ′_{d}³) is down-sampled to a next intermediate feature map [symbol] _{d}ⁱ⁺¹ (e.g., [symbol] _{d}², [symbol] _{d}³, and [symbol] _{d}⁴) by a down-sampling block, e.g., a max pooling layer with kernel size 2. The enhanced feature map [symbol] ′_{d}ⁱ (e.g., [symbol] ′_{d}¹, [symbol] ′_{d}², and [symbol] ′_{d}³) can be copied to feature up-sampling branch 1120 by a skip connection.

Then, the last down-sampled feature map [symbol] _{d}⁴ is enhanced by a base block 1130 to obtain the enhanced feature map [symbol] ′_{d}⁴, and the enhanced feature map [symbol] ′_{d}⁴ is fed to feature up-sampling branch 1120.

In feature up-sampling branch 1120, the enhanced feature map [symbol] ′_{d}⁴ and enhanced intermediate feature map [symbol] ′ᵤⁱ⁺¹ are up-sampled by an up-sampling block, for example, by convolution layer and pixel shuffle function with the upscaling factor of 2. Then, the up-sampled feature map is combined with the enhanced feature map [symbol] ′_{d}ⁱ (e.g., [symbol] ′_{d}¹, [symbol] ′_{d}², and [symbol] ′_{d}³) obtained by the skip connection. In some embodiments, the combination can be performed by concatenation operation, multiplication or addition operation. A channel size of the combined feature map is reduced by a down channel block 1121 and an intermediate up-sampled feature map [symbol] ᵤⁱ (e.g., [symbol] ᵤ³, [symbol] ᵤ², and [symbol] ᵤ¹) is obtained. In some embodiments, down channel block 1121 includes a convolution layer with kernel size 1. The base block 1122 is configured to enhance the intermediate up-sampled feature map [symbol] ᵤⁱ (e.g., [symbol] ᵤ² and [symbol] ᵤ³) to enhanced intermediate up-sampled feature map [symbol] ′ᵤⁱ (e.g., [symbol] ′ᵤ² and [symbol] ′ᵤ³) as an input to next up-sampling. The base block 1122 is also configured to enhance the intermediate up-sampled feature map [symbol] ᵤ¹ to enhanced up-sampled feature map [symbol] ′ᵤ¹ as an output of the feature up-sampling branch 1120. Finally, the output visual signal Iₒᵤₜ is obtained based on the final enhanced up-sampled feature map [symbol] ′ᵤ¹. In some embodiments, the base blocks 1111, 1130, and 1122 refer to baseline blocks in a visual signal restoration network to improve the visual signal enhancement performance. In some embodiments, base blocks 1111, 1130, and 1122 include Nonlinear Activation Free network (NAFNet) for image restoration, Residual Networks (ResNet), or Densely connected convolutional network (DenseNet).

Some embodiments of the present disclosure provide a quantization parameter (QP) adaptive visual signal enhancement network for post-processing to improve machine task performance.

For example, for the adaptability of QP, instead of inputting the QP, multiple trained post-processing networks can be used. For example, multiple post-processing networks are trained with different QPs. The multiple trained post-processing networks may in vary of level of samplings, type of each blocks, convolution layers, kernel size, or upscaling factor. Therefore, for a given QP, a target post-processing network can be selected from the multiple trained post-processing networks according to the QP, and an output visual signal is obtained based on the target post-processing network.

In some embodiments, the quantization parameter [symbol] could be replaced by other information format to represent the codec compression ratio, for example, Constant Rate Factor (CRF) or bitrate.

Some embodiments of the present disclosure further provide a lightweight post-processing network. In practical applications, the limited amount of computation capacity at the decoding side is focused on the real-time performance, model storage consumption, or computational consumption of post-processing methods. Consequently, the proposed post-processing network can be made lightweight to meet specific requirements. As such, the amount of computation and time consumption for the post-processing network can be reduced by reducing the kernel size, operation number, or feature size in the network. In some embodiments, the channel of feature map [symbol] , the depth of the feature up/down-sampling branches, and the number of base blocks (e.g., number of base blocks 1111, 1130, and 1122 in FIG. 11) can be reduced in the lightweight network to save computational consumption and model storage space and maintain the RA performance. For example, two configurations of the post-processing network can be used to make the computation of the post-processing network to Low Operational Point (LOP) and Very Low Operational Point (VLOP), respectively. For the LOP, the channel of the feature map [symbol] ⁱ is set to 32 j, the depth is set to 2, and the number of base block is set to 1, that is, only base block 1130 in FIG. 11 is kept. For the VLOP, the channel of the feature map [symbol] ⁱ is set to 16 j, and other settings (e.g., the depth and the number of base blocks) are same as LOP.

As illustrated above, consistent with the disclosed embodiments, depending on the specific application, the parameters of the post-processing network can be set to various values of the depth, the channel of feature map, and the number of base blocks) to meet the actual computation environment and workload.

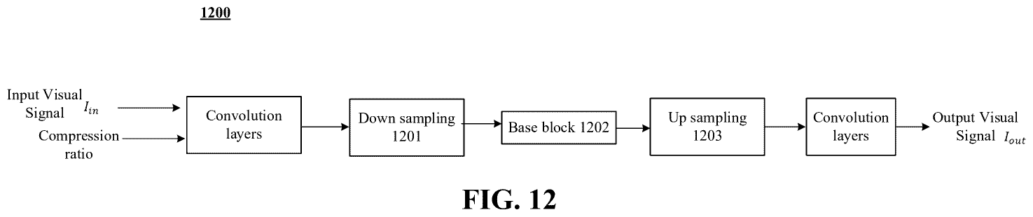

In some embodiments, one or more blocks can be removed or shortcut from the post-processing network to reduce consumption of the computation resources. For example, certain channels and blocks in FIG. 11 can be skipped, for example, skip connections and down channel block. FIG. 12 is a schematic diagram illustrating an exemplary lightweight post-processing network, according to some embodiments of the present disclosure. As shown in FIG. 12, lightweight post-processing network 1200 includes one down-sampling block 1202, one base block 1203, and one up-sampling block 1204. Feature map [symbol] _{d}¹ obtained based on input visual signal Iᵢₙ and compression ratio is down-sampled by down-sampling block 1202 to obtain a down-sampled feature map [symbol] _{d}². The down-sampled feature map [symbol] _{d}² is transformed by base block 1203 to enhanced down-sampled feature map [symbol] ′_{d}². The enhanced down-sampled feature map [symbol] ′_{d}² then up-sampled by up-sampling block 1204 to obtain an up-sampled feature map [symbol] ᵤ¹. Then the output visual signal Iₒᵤₜ is obtained based on the up-sampled feature map [symbol] ᵤ¹.

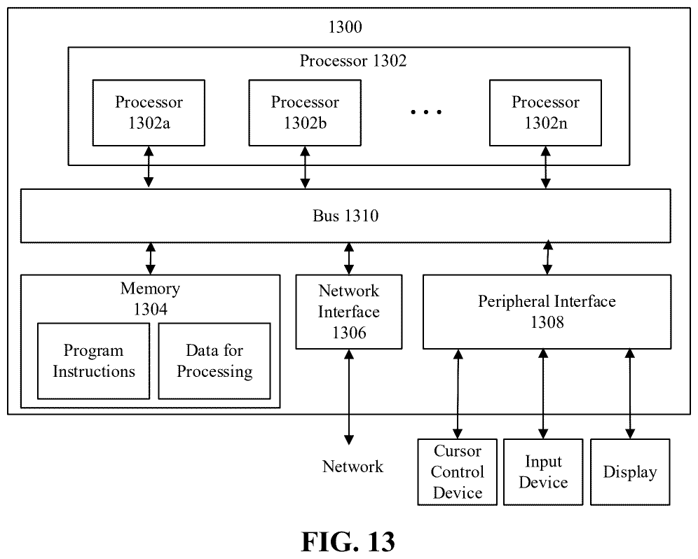

FIG. 13 is a block diagram of an exemplary apparatus 1300 for coding image data, according to some embodiments of the present disclosure. Apparatus 1300 can be used to perform the above-described video compression methods. As shown in FIG. 13, apparatus 1300 can include processor 1302. When processor 1302 executes instructions described herein, apparatus 1300 can become a specialized machine for video encoding or decoding. Processor 1302 can be any type of circuitry capable of manipulating or processing information. For example, processor 1302 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 1302 can also be a set of processors grouped as a single logical component. For example, as shown in FIG. 13, processor 1302 can include multiple processors, including processor 1302a, processor 1302b, and processor 1302n.

Apparatus 1300 can also include memory 1304 configured to store data (e.g., a set of instructions, computer codes, intermediate data, or the like). For example, as shown in FIG. 13, the stored data can include program instructions (e.g., program instructions for implementing the methods described in the present disclosure. Processor 1302 can access the program instructions and data for processing (e.g., via bus 1310), and execute the program instructions to perform an operation or manipulation on the data for processing. Memory 1304 can include a high-speed random-access storage device or a non-volatile storage device. In some embodiments, memory 1304 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 1304 can also be a group of memories (not shown in FIG. 13) grouped as a single logical component.

Bus 1310 can be a communication device that transfers data between components inside apparatus 1300, such as an internal bus (e.g., a CPU-memory bus), an external bus (e.g., a universal serial bus port, a peripheral component interconnect express port), or the like.

For ease of explanation without causing ambiguity, processor 1302 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 1300.

Apparatus 1300 can further include network interface 1306 to provide wired or wireless communication with a network (e.g., the Internet, an intranet, a local area network, a mobile communications network, or the like). In some embodiments, network interface 1306 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, apparatus 1300 can further include peripheral interface 1308 to provide a connection to one or more peripheral devices. As shown in FIG. 13, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs consistent with the present disclosure can be implemented as any combination of any software or hardware modules in apparatus 1300. For example, some or all stages of the disclosed methods can be implemented as one or more software modules of apparatus 1300, such as program instructions that can be loaded into memory 1304. For another example, some or all stages of the disclosed methods can be implemented as one or more hardware modules of apparatus 1300, such as a specialized data processing circuit (e.g., an FPGA, an ASIC, an NPU, or the like).

In some embodiments, a non-transitory computer-readable storage medium including instructions is also provided, and the instructions may be executed by a device (such as the disclosed codec, post-processing network and machine task network), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, or a memory.

It is noted that the embodiments described in the present disclosure can be freely combined or used separately.

The embodiments may further be described using the following clauses:

1. A video processing method, comprising:
compressing and reconstructing an original visual signal to obtain a reconstructed visual signal;
processing the reconstructed visual signal to obtain a post-processed visual signal; and
feeding the post-processed visual signal to a machine task network.

2. The method according to clause 1, wherein processing the reconstructed visual signal to obtain the post-processed visual signal further comprises:
processing the reconstructed visual signal based on compression ratio.

3. The method according to clause 2, wherein the compression ratio comprises: a quantization parameter, a constant rate factor (CFR), or a bitrate.

4. The method according to clause 2 or 3, wherein processing the reconstructed visual signal based on compression ratio further comprises:
obtaining an intermediate feature map based on the reconstructed visual signal and the compression ratio;
performing feature down-sampling on the intermediate feature map to obtain a down-sampled feature map;
transforming the down-sampled feature map to obtain an enhanced feature map; and
performing feature up-sampling on the enhanced feature map to obtain an up-sampled feature map.

5. The method according to clause 4, wherein obtaining the intermediate feature map based on the reconstructed visual signal and the compression ratio further comprises:
expanding the compression ratio to a same size of the reconstructed visual signal; and
obtaining the intermediate feature map based on a combination of the expanded compression ratio and the reconstructed visual signal.

6. The method according to clause 4, wherein performing feature down-sampling on the intermediate feature map to obtain the down-sampled feature map further comprises:
transforming the intermediate feature map to an enhanced intermediate feature map; and
performing the feature down-sampling on the enhanced intermediate feature map to obtain the down-sampled feature map; and
wherein performing feature up-sampling on the enhanced feature map to obtain the up-sampled feature map comprises:
transforming the up-sampled feature map to an enhanced up-sampled feature map.

7. The method according to clause 6, wherein performing feature up-sampling on the enhanced feature map to obtain the up-sampled feature map further comprises:
performing feature up-sampling on the enhanced feature map to obtain an intermediate up-sampled feature map; and
reducing a channel size of the combination of the enhanced intermediate feature map and the intermediate up-sampled feature map to obtain the up-sampled feature map.

8. The method according to clause 7, further comprising:
performing one or more layers of the feature down-sampling and the feature up-samplings, wherein a number of layers of the feature down-sampling and a number of the feature up-samplings are the same.

9. The method according to any one of clauses 4 to 8, wherein a channel of feature map is 32 j or 16 j.

10. The method according to any one of clauses 1 to 9, further comprising obtaining a loss function by: [symbol] ₐₗₗ=λ_{D} [symbol] _{D}+λ_{F} [symbol] _{F}, where [symbol] _{D} is a visual signal distortion loss, [symbol] _{F} is a feature distortion loss, λ_{D} is a hyper-parameter of a weight for the visual signal distortion loss, and λ_{F} is a hyper-parameter of a weight for the feature distortion loss.

11. The method according to clause 10, wherein the visual signal distortion loss is calculated based on a loss of the original visual signal and the post-processed visual signal.

12. The method according to clause 10, wherein the feature distortion loss is generated based on the machine task network and a feature map of the machine task network.

13. A video procession system, comprising:
a codec configured to compress and reconstruct an original visual signal to obtain a reconstructed visual signal;
a post-processing network configured to process the reconstructed visual signal to obtain a post-processed visual signal; and
a machine task network configured to process the post-processed visual signal.

14. The system according to clause 13, wherein the post-processing network further comprises:
a feature down-sampling branch configured to down-sample a feature map of the original visual signal to obtain a down-sampled feature map; and
a base block configured to transform a down-sampled feature map to an enhanced down-sampled feature map; and
a feature up-sampling branch configured to up-sample the enhanced down-sampled feature map to an up-sampled feature map.

15. The system according to clause 14, wherein the feature down-sampling branch further comprises:
one or more base blocks configured to enhance a feature map; and
one or more down-sampling block corresponding to the one or more base blocks and configured to down-sample the enhanced feature map.

16. The system according to clause 15, wherein the feature up-sampling branch further comprises:
one or more up-sampling block configured to up-sample a feature map; and
one or more base blocks configured to enhance the up-sampled feature map to an enhanced up-sampled feature map.

17. The system according to clause 15, wherein the feature up-sampling branch further comprises:
one or more down-channel block configured to reduce a channel size of a combination of the enhanced feature map and the up-sampled feature map.

18. A non-transitory computer readable medium that stores a set of instructions that is executable by one or more processors of an apparatus to cause the apparatus to perform operations comprising:
compressing and reconstructing an original visual signal to obtain a reconstructed visual signal;
processing the reconstructed visual signal to obtain a post-processed visual signal; and
feeding the post-processed visual signal to a machine task network.

19. The non-transitory computer readable medium according to clause 18, wherein processing the reconstructed visual signal to obtain the post-processed visual signal further comprises:
processing the reconstructed visual signal based on compression ratio.

20. The non-transitory computer readable medium according to clause 19, wherein the compression ratio comprises: a quantization parameter, a constant rate factor (CFR), or a bitrate.

21. The non-transitory computer readable medium according to clause 19, wherein processing the reconstructed visual signal based on compression ratio further comprises:
obtaining an intermediate feature map based on the reconstructed visual signal and the compression ratio;
performing feature down-sampling on the intermediate feature map to obtain a down-sampled feature map;
transforming the down-sampled feature map to obtain an enhanced feature map; and
performing feature up-sampling on the enhanced feature map to obtain an up-sampled feature map.

22. The non-transitory computer readable medium according to clause 21, wherein obtaining the intermediate feature map based on the reconstructed visual signal and the compression ratio further comprises:
expanding the compression ratio to a same size of the reconstructed visual signal; and
obtaining the intermediate feature map based on a combination of the expanded compression ratio and the reconstructed visual signal.

23. The non-transitory computer readable medium according to clause 21, wherein performing feature down-sampling on the intermediate feature map to obtain the down-sampled feature map further comprises:
transforming the intermediate feature map to an enhanced intermediate feature map; and
performing the feature down-sampling on the enhanced intermediate feature map to obtain the down-sampled feature map; and
wherein performing feature up-sampling on the enhanced feature map to obtain the up-sampled feature map comprises:
transforming the up-sampled feature map to an enhanced up-sampled feature map.

24. The non-transitory computer readable medium according to clause 23, wherein performing feature up-sampling on the enhanced feature map to obtain the up-sampled feature map further comprises:
performing feature up-sampling on the enhanced feature map to obtain an intermediate up-sampled feature map; and
reducing a channel size of the combination of the enhanced intermediate feature map and the intermediate up-sampled feature map to obtain the up-sampled feature map.

25. The non-transitory computer readable medium according to clause 24, wherein the operations further comprise:
performing one or more layers of the feature down-sampling and the feature up-samplings, wherein a number of layers of the feature down-sampling and a number of the feature up-samplings are the same.

26. The non-transitory computer readable medium according to clause 21, wherein a channel of feature map is 32 j or 16 j.

27. The non-transitory computer readable medium according to clause 18, wherein the operations further comprise:
obtaining a loss function by: [symbol] ₐₗₗ=λ_{D} [symbol] _{D}+λ_{F} [symbol] _{F}, where [symbol] _{D} is a visual signal distortion loss, [symbol] _{F} is a feature distortion loss, λ_{D} is a hyper-parameter of a weight for the visual signal distortion loss, and λ_{F} is a hyper-parameter of a weight for the feature distortion loss.

28. The non-transitory computer readable medium according to clause 27, wherein the visual signal distortion loss is calculated based on a loss of the original visual signal and the post-processed visual signal.

29. The non-transitory computer readable medium according to clause 27, wherein the feature distortion loss is generated based on the machine task network and a feature map of the machine task network.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video processing method, comprising:
compressing and reconstructing an original visual signal to obtain a reconstructed visual signal;
processing the reconstructed visual signal to obtain a post-processed visual signal; and
feeding the post-processed visual signal to a machine task network.

2. The method according to claim 1, wherein processing the reconstructed visual signal to obtain the post-processed visual signal further comprises:
processing the reconstructed visual signal based on compression ratio.

3. The method according to claim 2, wherein processing the reconstructed visual signal based on compression ratio further comprises:
obtaining an intermediate feature map based on the reconstructed visual signal and the compression ratio;
performing feature down-sampling on the intermediate feature map to obtain a down-sampled feature map;
transforming the down-sampled feature map to obtain an enhanced feature map; and
performing feature up-sampling on the enhanced feature map to obtain an up-sampled feature map.

4. The method according to claim 3, wherein obtaining the intermediate feature map based on the reconstructed visual signal and the compression ratio further comprises:
expanding the compression ratio to a same size of the reconstructed visual signal; and
obtaining the intermediate feature map based on a combination of the expanded compression ratio and the reconstructed visual signal.

5. The method according to claim 3, wherein performing feature down-sampling on the intermediate feature map to obtain the down-sampled feature map further comprises:
transforming the intermediate feature map to an enhanced intermediate feature map; and
performing the feature down-sampling on the enhanced intermediate feature map to obtain the down-sampled feature map; and
wherein performing feature up-sampling on the enhanced feature map to obtain the up-sampled feature map comprises:
transforming the up-sampled feature map to an enhanced up-sampled feature map.

6. The method according to claim 5, wherein performing feature up-sampling on the enhanced feature map to obtain the up-sampled feature map further comprises:
performing feature up-sampling on the enhanced feature map to obtain an intermediate up-sampled feature map; and
reducing a channel size of the combination of the enhanced intermediate feature map and the intermediate up-sampled feature map to obtain the up-sampled feature map.

7. The method according to claim 1, further comprising obtaining a loss function by: [symbol] ₐₗₗ=λ_{D} [symbol] _{D}+λ_{F} [symbol] _{F}, where [symbol] _{D} is a visual signal distortion loss, [symbol] _{F} is a feature distortion loss, λ_{D} is a hyper-parameter of a weight for the visual signal distortion loss, and λ_{F} is a hyper-parameter of a weight for the feature distortion loss.

8. The method according to claim 7, wherein the visual signal distortion loss is calculated based on a loss of the original visual signal and the post-processed visual signal.

9. The method according to claim 7, wherein the feature distortion loss is generated based on the machine task network and a feature map of the machine task network.

10. A video procession system, comprising:
a codec configured to compress and reconstruct an original visual signal to obtain a reconstructed visual signal;
a post-processing network configured to process the reconstructed visual signal to obtain a post-processed visual signal; and
a machine task network configured to process the post-processed visual signal.

11. The system according to claim 10, wherein the post-processing network further comprises:
a feature down-sampling branch configured to down-sample a feature map of the original visual signal to obtain a down-sampled feature map; and
a base block configured to transform a down-sampled feature map to an enhanced down-sampled feature map; and
a feature up-sampling branch configured to up-sample the enhanced down-sampled feature map to an up-sampled feature map.

12. The system according to claim 11, wherein the feature down-sampling branch further comprises:
one or more base blocks configured to enhance a feature map; and
one or more down-sampling block corresponding to the one or more base blocks and configured to down-sample the enhanced feature map.

13. The system according to claim 12, wherein the feature up-sampling branch further comprises:
one or more up-sampling block configured to up-sample a feature map; and
one or more base blocks configured to enhance the up-sampled feature map to an enhanced up-sampled feature map.

14. The system according to claim 12, wherein the feature up-sampling branch further comprises:
one or more down-channel block configured to reduce a channel size of a combination of the enhanced feature map and the up-sampled feature map.

15. A non-transitory computer readable medium that stores a set of instructions that is executable by one or more processors of an apparatus to cause the apparatus to perform operations comprising:
compressing and reconstructing an original visual signal to obtain a reconstructed visual signal;
processing the reconstructed visual signal to obtain a post-processed visual signal; and
feeding the post-processed visual signal to a machine task network.

16. The non-transitory computer readable medium according to claim 15, wherein processing the reconstructed visual signal to obtain the post-processed visual signal further comprises:
processing the reconstructed visual signal based on compression ratio.

17. The non-transitory computer readable medium according to claim 16, wherein processing the reconstructed visual signal based on compression ratio further comprises:
obtaining an intermediate feature map based on the reconstructed visual signal and the compression ratio;
performing feature down-sampling on the intermediate feature map to obtain a down-sampled feature map;
transforming the down-sampled feature map to obtain an enhanced feature map; and
performing feature up-sampling on the enhanced feature map to obtain an up-sampled feature map.

18. The non-transitory computer readable medium according to claim 17, wherein obtaining the intermediate feature map based on the reconstructed visual signal and the compression ratio further comprises:
expanding the compression ratio to a same size of the reconstructed visual signal; and
obtaining the intermediate feature map based on a combination of the expanded compression ratio and the reconstructed visual signal.

19. The non-transitory computer readable medium according to claim 17, wherein performing feature down-sampling on the intermediate feature map to obtain the down-sampled feature map further comprises:
transforming the intermediate feature map to an enhanced intermediate feature map; and
performing the feature down-sampling on the enhanced intermediate feature map to obtain the down-sampled feature map; and
wherein performing feature up-sampling on the enhanced feature map to obtain the up-sampled feature map comprises:
transforming the up-sampled feature map to an enhanced up-sampled feature map.

20. The non-transitory computer readable medium according to claim 15, wherein the operations further comprise:
obtaining a loss function by: [symbol] ₐₗₗ=λ_{D} [symbol] _{D}+λ_{F} [symbol] _{F}, where [symbol] _{D} is a visual signal distortion loss, [symbol] _{F} is a feature distortion loss, λ_{D} is a hyper-parameter of a weight for the visual signal distortion loss, and λ_{F} is a hyper-parameter of a weight for the feature distortion loss.
